(19) United States
(12) Patent Application Publication
(10) Pub. No.: US 2011/0049822 A1
(43) Pub. Date: Mar. 3, 2011

(54) Plumber's unibody creeper

(76) Inventor: Peter Hinman, New Hartford, CT (US)

(21) Appl. No.: 12/807,012

(22) Filed: Aug. 26, 2010

Related U.S. Application Data
(60) Provisional application No. 61/275,287, filed on Aug. 27, 2009.
(60) Provisional application No. 61/281,633, filed on Nov. 19, 2009.

(51) Int. Cl. B25H 5/00

(52) U.S. Cl. 280/32.6

(57) ABSTRACT

A creeper device is provided in a unibody platform to provide highly maneuverable support for a person in a generally horizontal position with either a rigid one piece platform or alternatively, with a two piece foldable hinged construction for convenient transport and storage. The unibody creeper comprises a bottom side having wheels or casters mounted thereon and a top side which may include a foam pad or cushion to support the user comfortably. The wheels are attached to the underside of the support platform and allow the device to be readily moved and maneuvered by the user. The wheels are affixed and positioned such that the head end of the creeper is cantilever supported beyond the forward most wheels to enable a person to enter the opening of a sink type cabinet door and navigate above the raised toe kickboard and cabinet floor while the creeper wheels remain on the floor outside of the cabinet. The wheel attaching means further include provisions to adjust the height of the platform to accommodate varying cabinet toe kickboard heights. The unibody platform head end supports the person's head and upper torso while working within the confined cabinet space. The unibody platform head end further comprises two substantially semi-circle cutouts provided within the cantilevered portion of the platform such that the device can be moved or placed into cabinets exhibiting a smaller entry port than the full width of the device. These semi-circle cutouts also facilitate improved range of motion of the person's arms and shoulders while remaining supported by the head end to prevent head and back strain. The unibody creeper device may further comprise a drawer for storing easily accessible tools, a carrying handle and a lighting lamp on the head end.

### CROSS-REFERENCE

Priority and benefit of earlier filing date of provisional application Ser. No. 61/275,287 filed Aug. 27, 2009 and provisional application Ser. No. 61/281,633 filed Nov. 19, 2009 are claimed.

### FIELD OF THE INVENTION

The present invention relates to a movable worker platform commonly referred to as a creeper or crawler on which a person lies on his back in order to maneuver into or underneath low and confined spaces. More particularly, the present invention creeper is designed for plumbers and alike to facilitate working underneath kitchen sinks and similar confined and raised spaces relative to the floor level. The plumbers field has developed several devices to address the particular nuances of a worker lying on his back and trying to navigate into the cabinet while supporting his upper torso weight over the varying transitional height represented by the floor surface and the elevated inside cabinet floor caused by the cabinet toe kickboard which typically ranges from 3½ to 5½ inches high.

### BACKGROUND OF THE INVENTION

### Brief Description of the Related Art

While many tools and devices have been developed in attempt to improve the plumber's access, support, comfort and maneuverability while working inside a cabinet such as with kitchen sink plumbing; each has unique limitations and disadvantages when compared to that of the instant creeper invention. Practitioners have generally referred to the plumber lying on his back and facing upward as working in the supine position. The essence of most of the focus of these other designs is the transition from the floor surface to that of the slightly elevated cabinet floor typically some 3½ to 5½ inches higher and in particular, the sharp edge or corner where the elevated cabinet door opening floor meets the vertical cabinet toe kickboard. This raised right angle obstruction has given plumbers fits and indeed physical pain since its inception as it generally serves as a painful pressure point while working underneath the sink. Plumbers and homeowners alike have traditionally attempted to soften the raised toe kickboard corner by placing a blanket, pillow or rubber mats adjacent to and/or on top of the sharp corner.

Traditional automotive style floor creeper designs, while offering maneuverability, lack vertical height adjustment to accommodate varying toe kickboard heights and by design, stop at the cabinet door entrance, thus offering no body support or head and torso strain relief once the person is inside the confined cabinet. One commonly employed device configuration is that of the “wedge”, e.g., a triangular cross-section or ramp positioned in attempt to provide a gradual transition from the floor to the raised cabinet floor. These designs however, whether constructed of substantially structural materials or foam, are generally also not adjustable in height to accommodate varying toe kickboard heights, and offer no maneuverability to the worker as the wedge rests on the exterior floor without the aid of swiveling wheels for instance.

Beck's U.S. Patent Application No. 2006/0200909 attempts improvement to this basic ramp design by incorporating a horizontal “back support platform” which is supported at the top of the ramp and a horizontal portion thereof enters the cabinet. However, this claimed improvement does nothing to improve mobility or maneuverability of the plumber and by design still incorporates a 20 degree angle between the ramp and back support section. Schlieps' U.S. Pat. No. 7,305,728 joins two identical foam wedges together whereby one wedge remains on the floor while the other wedge is flipped up an into the cabinet opening to rest on the cabinet floor, again offering nothing to improve worker maneuverability nor adjustable toe kickboard height accommodation. In fact, the wedge plus wedge geometry raises the worker up off the cabinet floor to a height which may jeopardize his ability to move his arms freely. There are also ample instances and scenarios when it is not desirable for the device of choice to be in contact with a potentially contaminated cabinet floor for instance. Similarly the Bailey twin wedge design in U.S. Pat. No. 7,007,328 suffers the same limitations as already noted but further compounds the loss of worker maneuverability by compounding the two corresponding wedge angles to significantly raise the worker off of the cabinet floor.

Correspondingly, other devices have been developed in attempt to garnish the fundamental maneuverability virtues of the automotive style creeper for plumber application. A common approach has been to incorporate an extendable, slide-able, pivot-able and some times adjustable headrest type device which can be deployed from the head end of the creeper platform such as with Nicholson's U.S. Pat. No. 5,330,211, Chamberlin's U.S. Pat. No. 4,889,352 and Smith's U.S. Pat. No. 5,707,067. None of these devices, however, is aimed at accomplishing much more than supporting the worker's head and do not substantially improve the worker's lateral transition into the cabinet door opening as the wheeled platform is still restricted at the toe kickboard. The overall reach of these headrests are limited, offering no upper torso or back support within the confines of the cabinet and the platforms incorporate no height adjustment capabilities.

The Larson style creeper device of U.S. Pat. No. 3,677,569, while again not incorporating a height adjustment capability, does incorporate a hinged or folding extender section intended to enter the confines of the cabinet enclosure in order to better support the worker. However, the extender section is the same width as the wheeled platform, and thus has not been tailored to allow entry into cabinet door openings narrower than the wheeled platform such as with the present invention, nor does it teach height adjustment of the platform.

In addition, the Larson extender is fitted with yet another wheel which is intended to rest on the cabinet interior floor surface to support the weight of the worker as opposed to the instant device's ability to support the weight of the worker in cantilever fashion and thereby not requiring contact with the cabinet floor. The cantilever support of the head end section of the present invention allows for more worker clearance as the platform height can be adjusted for only minimal clearance of the head end over the cabinet floor. This “non-contact” feature of the present invention also ensures that the creeper is not contaminated by residual products and chemicals that may be on the cabinet floor surface. The Larson creeper requires the extender wheel to be supported by the cabinet floor as opposed to being independently supported like the instant device head end and thus the Larson device poses an instability concern and potentially a safety issue as the worker exits the cabinet in the supine position and the extender wheel rolls off of the elevated toe kickboard. Contrarily, the worker can lie upon the instant device completely outside of the cabinet even perpendicular to the line of axis to the cabinet entry and easily pivot and maneuver into the cabinet opening, thus offering a significant maneuverability advantage.

The Parks crawler disclosed under U.S. Pat. No. 5,577,744 provides for an angular adjustable support similar to a seat back which can be adjusted down to a near prone position. It, however, does not teach height adjustment to accommodate varying height toe kickboards, tends to compromise the space remaining for the worker to maneuver once inside the cabinet similar to the wedge designs, does not teach the narrowing cut-outs and is not of the unibody construction.

It is there an object of the present invention to overcome the shortcomings of the prior art described above and otherwise known in the art. It also is an object of the present invention to provide a highly maneuverable creeper which allows navigation and traversal over the toe kickboard height of a typical sink cabinet while supporting the upper torso and head of the person in the supine position.

Another object of the present invention is to provide a height adjustable means to raise or lower the creeper platform to accommodate varying sink cabinet toe kickboard heights.

A further object of the present invention is to provide a foldable creeper for easy transport and storage comprising all of the features and benefits of the one piece creeper.

A still further object of the present invention is to provide a carrying handle, tool storage drawer and flexible accessory lamp for improved lighting.

### SUMMARY OF THE INVENTION

The present invention relates to a floor-maneuverable platform commonly referred to as a creeper or crawler on which the person lies on his back in order to maneuver into or underneath low and confined spaces. More particularly, the present invention creeper is designed for plumbers to facilitate working underneath kitchen sinks and similar confined and slightly raised spaces relative to the floor level. The device is utilized by plumbers to navigate into the cabinet while supporting the person's upper torso weight over the varying transitional height represented by the elevated inside cabinet floor caused by the cabinet toe kickboard which typically ranges from 3½ to 5½ inches high, relative to the room floor.

One preferred embodiment of the invention comprises a one-piece unibody style platform. The creeper platform comprises a bottom side having four wheels or casters mounted thereon and a top side which may include a foam pad or cushion to support the user comfortably. The wheels are attached to the underside of the support platform and allow the device to be readily moved by the user. The wheels are affixed and positioned such that the head end of the creeper is cantilever supported beyond the forward most wheels to enable a person to enter the opening of a sink type cabinet door and navigate above the raised toe kickboard and cabinet floor while the creeper wheels remain on the floor outside of the cabinet. The wheel attaching means further include provisions to adjust the height of the platform to accommodate varying cabinet toe kickboard heights while maximizing the workers clearance and maneuverability within the cabinet interior.

The unibody platform head end supports the person's head and upper torso while working within the confined cabinet space to prevent head, neck and torso strain. The unibody platform head end further comprises two substantially semi-circle cutouts provided within the cantilevered portion of the platform such that the device can be moved or placed into cabinets exhibiting a smaller entry port than the full width of the device. These semi-circle cutouts also facilitate improved range of motion of the person's arms and shoulders while remaining supported by the head end. The creeper device may further comprise a drawer for storing easily accessible tools, tool caddy, a carrying handle and a lighting lamp on the head end. The lamp is mounted on a flexible neck which attaches to the underside of the platform so that the lamp may also be stored out of the way or directed as desired.

In an alternate preferred embodiment, the unibody platform is split into two sections which are hingeably attached perpendicular to the longitudinal axis of the platform. The foot end of the platform comprises the height adjustable wheeled section and the head end is cantilever supported by the foot end and comprises the two substantially semi-circle cutouts described above. The hinged unibody version can be folded and latched closed for convenient transport and storage, likewise comprises a handle, and may also comprise a drawer for storing easily accessible tools, tool caddy and a lighting lamp on the head end. A slide-bolt mechanism is utilized to support and lock the head end juxtaposed to and co-planer with the foot end during use to form one aggregate surface.

In further detail, the present invention comprises a creeper to provide a substantially flat, rollable working surface capable of supporting a person in a supine position. The present device includes a rigid planar platform that defines a top surface, a bottom surface, perimeter edge surfaces, a first end and a second end. It also includes a plurality of wheels mounted on the bottom surface to provide for rollably engaging a floor or ground surface. The wheels are attached to the rigid planar platform in a spatial relationship relative to the first end of the platform. In this manner, the device will support a person's upper torso weight that is applied to the second end of the platform and also provide entry into a confined workspace. The second end of the platform extends in an elevated cantilever fashion into the confined workspace and is not supported by any wheels. A preferred embodiment of the present device may further comprise a plurality of height adjustment mechanisms to change the distance of the wheels from the bottom surface of the platform in order to change the height of the platform relative to the floor or ground surface on which the wheels will be placed.

The cantilevered platform extension may define a narrower lateral width than the portion of the platform supported by the wheels to enable the creeper cantilevered extension to enter door openings of lesser width than that of the portion of the platform supported by the wheels. In this embodiment, the cantilevered platform extension defines a lateral narrowing geometric shape localized to the area of the platform extension immediately adjacent to the wheel(s) closest to the point of the cantilever fulcrum to enable the creeper cantilevered extension to negotiate door openings of lesser width than that of the portion of the platform supported by the wheels while providing a laterally wider work surface beyond the localized narrowing region. The cantilevered platform extension lateral narrowing geometric shapes are typically in the form of two semi-circle cutouts with the corresponding radii facing each other.

Alternatively, the present invention may comprise a foldable creeper that provides the substantially flat, rollable working surface capable of supporting a person in a supine position. The rigid planar platform further comprises two movable platform segments hingeably attached to one another, each having a top surface, a bottom surface and perimeter edge surfaces. The device includes a plurality of wheels mounted to the bottom surface of one of the platform segments for rollably engaging a floor or ground surface. The wheels are attached to the rigid planar platform segment in a spatial relationship substantially about the perimeter of the platform segment so as to support weight applied to the top surface of both or either platform segments. The second platform segment may be locked and supported in a position adjacent, juxtaposed to and co-planer with the platform segment comprising the wheels to form a cantilevered platform. The cantilevered platform segment is supported and locked into the co-planer position by at least one moveable structural support member mechanism which is substantially perpendicular to the axis of the hinge system and bridges the two movable platform segments.

The foldable creeper similarly may include a plurality of height adjustment mechanisms to change the distance of the wheels from the bottom surface of the platform in order to change the height of the platform relative to the floor or ground surface on which the wheels will be placed. Again, the cantilevered platform segment may define a narrower width than the platform segment supported by the wheels to enable the creeper cantilevered extension to enter door openings of lesser width than that of the portion of the platform supported by the wheels. The cantilevered platform segment defines a lateral narrowing cross-section generally localized to the area of the platform extension starting immediately adjacent to the hinge system and the point of the cantilever fulcrum to enable the creeper cantilevered extension to negotiate door openings of lesser width than that of the platform segment supported by the wheels while providing a laterally wider work surface beyond the localized narrowing region. Again, the cantilevered platform segment lateral narrowing geometric shapes are typically in the form of two semi-circle cutouts with the corresponding radii facing each other.

One embodiment of the moveable structural support member mechanism defines at least one moveable slide bolt and at least one slide bolt receiving receptacle mechanism affixed to each platform segment. The structural support member mechanism provides the means to independently support and retain the moveable disengaged slide bolt to one of the platform segments in the fully retracted and disengaged position such that the moveable slide bolt lineal length does not cross the plane of the hinge system. This embodiment provides the device with the ca foldable creeper capability to fold the cantileverable platform segment approximately 180 degrees about the hinge system axis until the bottom surface of the cantilevered platform is substantially in contact with the bottom surface of the wheeled platform segment. A latch mechanism secures the two platform segments together for ease of transport and storage.

As stated hereinabove, additional embodiments of the present invention may further define any combination or plurality of carrying handles, storage drawers, platform cushions, wheel support bumpers or lighting lamps.

### BRIEF DESCRIPTION OF THE DRAWINGS

FIG. 1 is a perspective top view of the one piece unibody creeper.

FIG. 2 is a perspective top view of the one piece unibody creeper with optional platform cushioning, drawer, carrying handle and flexible directional lamp.

FIG. 3 is a perspective top view of the two piece foldable unibody creeper forming a second embodiment.

FIG. 4 is a perspective bottom view of the two piece foldable unibody creeper in the extended and locked position.

FIG. 5 is a perspective bottom view of the two piece foldable unibody creeper with the head end of the platform folded near the storage position.

FIG. 6 is a partial perspective bottom view of the wheels, wheel mounting bracket and height adjustment means.

FIG. 7 is a perspective view of the unibody creeper cantilevered head end extending over the toe kickboard and into a wide cabinet door opening.

FIG. 8 is a perspective view of the unibody creeper cantilevered head end extending over the toe kickboard and into a narrow cabinet door opening as facilitated by the head end semi-circle cutouts.

FIG. 9A is a side elevation view of the unibody creeper cantilevered head end extending over the toe kickboard and horizontally positioned just above the cabinet floor.

FIG. 9B is a side elevation view of the unibody creeper with the front and rear wheel heights being correspondingly adjusted so as to raise the cantilevered head end slightly higher than a position parallel to the cabinet floor.

### DESCRIPTION OF THE PREFERRED EMBODIMENT

Although the disclosure hereof is detailed and exact to enable those skilled in the art to practice the invention, the physical embodiments therein disclosed merely exemplify the invention which may be embodied in other specific structure. While the disclosed preferred embodiments have been described, the details may be changed without departing from the invention, which is defined by the claims.

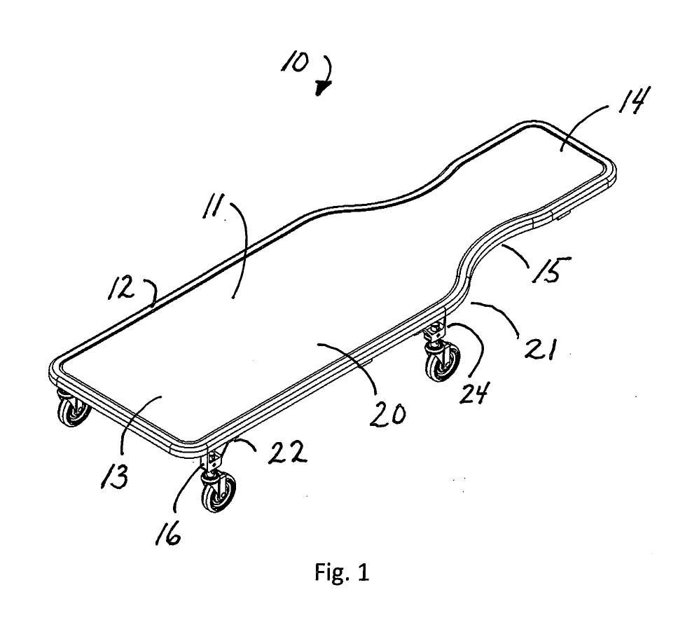

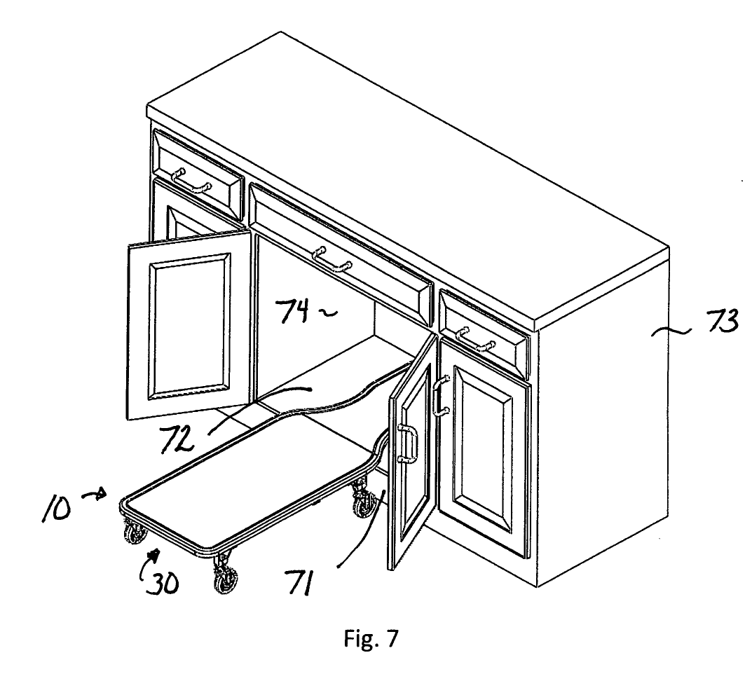

Referring to the drawings, wherein like referenced characters designate corresponding parts throughout the several figures, the preferred embodiments of the invention include both a one piece unibody creeper 10 embodiment and a folding two piece unibody creeper 30 embodiment as shown in FIGS. 1 through 9. For the purpose of clarity, all of the features, elements and attributes of the one piece unibody creeper 10 are likewise applicable to the folding two piece unibody creeper 30 unless otherwise specified. Those features, elements and attributes applicable only to the folding two piece unibody creeper 30 are so indicated.

FIG. 1 depicts the one piece unibody creeper 10 comprising a body-carrying platform 11. In use, the individual lies on his back with his head positioned at the head end 14 and his hips and upper legs upon the foot end 13. While many construction techniques are possible for the platform, the depicted preferred embodiment of the device comprises a metal frame 12, preferably of light weight aluminum, however, any suitably rigid material will suffice, and a plywood, plastic or other synthetic sheet stock to form the platform 20. The frame 12 may be of machined, stamped, extruded or otherwise formed by any number of known means to form the body-carrying platform 11 dual purpose edge protector and structural frame. The platform 20 may be mechanically attached to the frame 12 via conventional fastener techniques such as but not limited to screws, bolts, welding, adhesive and rivets. The entire body-carrying platform 11 may alternatively be fabricated or otherwise molded from suitably strong and rigid plastic, resin or other synthetic material, thereby obviating the need for separate frame 12 and platform 20 elements.

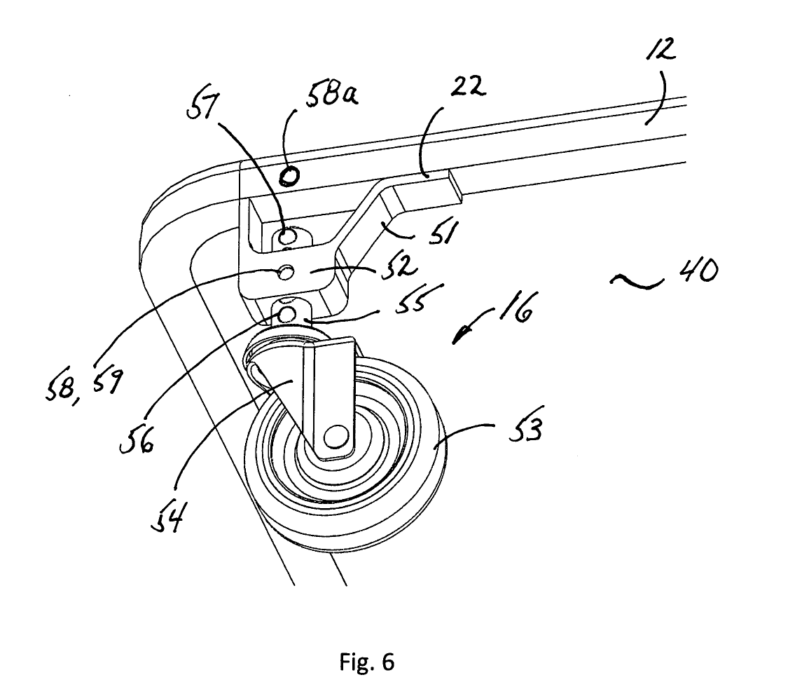

Each the one piece unibody creeper 10 embodiment and the folding two piece unibody creeper 30 preferred embodiment comprise four integrated roller and height adjustment assemblies 16 as further depicted in FIG. 6. A preferable embodiment for engaging the floor or other working surface comprises rotatable wheel assemblies or swivel casters 54. Such independently swiveling assemblies provide the worker with the capability to lie on the unibody creeper 10/30 in the supine position in virtually any orientation relative to the cabinet opening as space permits, and then easily pivot and rotate the unibody creeper 10/30 into position in order to slide the unibody creeper device 10/30 head end 14 forward into the cabinet opening 74, manipulate the unibody creeper 10/30 orientation once in the cabinet 74 while working, and backward out of the cabinet opening 74 with ease.

Two roller and height adjustment assemblies 16 are positioned on the bottom surface of the platform 40 at the approximate longitudinal midway point 21 of the platform 11, and define the point of the maximum platform head end 14 cantilever extension over the cabinet floor 72; and two roller and height adjustment assemblies 16 are positioned near the back edge 22 of the foot end 13 of the platform 11.

All four of the roller and height adjustment assemblies 16 are mechanically affixed to either the frame 12 or the bottom surface of the platform 11 via a suitably strong bracket 51 and are intended to remain on the floor to provide a stable base for the cantilevered head end 14. Those skilled in the art will recognize that other embodiments of the invention are foreseeable that may comprise additional or fewer roller and height adjustment assemblies 16, and are so anticipated hereunder. The roller and height adjustment assemblies 16 comprise any of a wide variety of swiveling, pivoting, gliding, sliding, rolling, revolving, rotating 54 or otherwise suitable casters, wheels or rollers 53 configured to provide maximum maneuverability. The rollers are likewise comprised of suitable material such as rubber, plastic, resin, polyurethane, synthetic, wood or metal which will provide low friction maneuverability without damaging, marring or other deleterious effect to the floor material 75. The forward vertical surfaces of the bracket 51 are formed to receive a bumper pad 24 to protect the cabinet face 73 or toe kick board 71 of the cabinet that may contact the bracket otherwise. The bumper pad 24 may be fabricated from any number of cushioning materials such as but not limited to cellular foam or rubber, and is mechanically affixed to the bracket 51 by any conventional fastener or adhesive, or can be removeably affixed such as with Velco.

The height adjustment assemblies 55 should be fabricated such that the height of the deck platform 11 is adjustable up or down as required whereby the cantilevered portion of the platform 14 is elevated high enough to: (i) clear the toe kick board 71; (ii) exceed the elevation of the cabinet floor 72; and (iii) achieve unobstructed entry into the cabinet core 74.

Such height adjustment means may be fabricated from any number of suitable materials and techniques such as but not limited to threaded rods, spring clip and notch, and sprung loaded captive detent pins, among others, and constructed of suitable material to carry the load while being removeably fastened or adjusted to provide for a variety of heights. As shown in FIG. 6, a preferable embodiment for providing a convenient adjustable height assembly 55 comprises wheel assemblies 54 with vertical support rods 56 or posts connecting the wheel swivel assembly 54 to the mounting bracket 51 wherein the mounting bracket 51 further comprises a receptacle 52 to accept the vertical support rod 56 and provides for vertical movement of the vertical support rod 56 relative to and through the receptacle 52.

The receptacle 52 further comprises at least one aperture 58 oriented substantially perpendicular to the vertical axis and centerline of the vertical support rods 56. The vertical support rod 56 comprises a plurality of apertures 57 spaced along its axial length which are likewise oriented substantially perpendicular to the vertical axis and centerline of the vertical support rods 56. The apertures 57 in the vertical support rods 56 are of substantially the same size and shape as the apertures 58 in the receptacle 52 and aperture 58a in frame 12 and are intended to accept and engage a pin 59 (not shown) placed substantially parallel to the plane of the platform 11, through one side of the receptacle 52 aperture 58, through the support rods 56 aperture 57 and on through the opposite side second receptacle 52 aperture 58, thereby securing the vertical support rods 56 at a particular wheel height. The pin 59 may be of any number of removeably configured fasteners including but not limited to bolt and nut, pin and clevis, pin and snap ring, or a pin with sprung loaded detent button or other protrusion, or any other similar means for height adjustment of the wheel assemblies when engaging the mounting bracket.

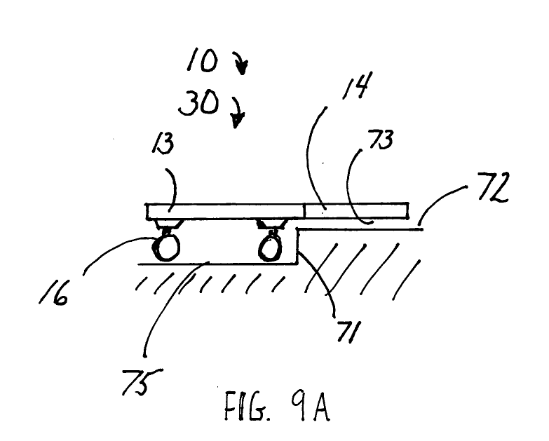

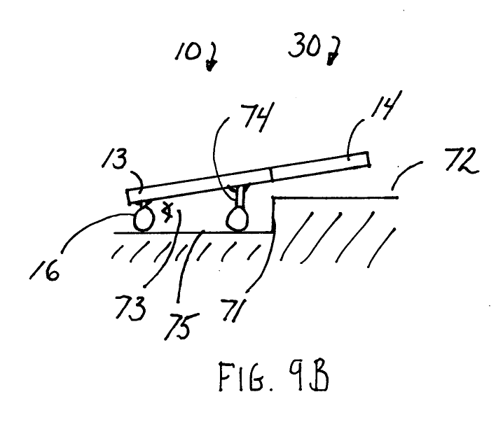

It is foreseen that those skilled in the art will recognize that the wheel and height adjustment means may be accomplished in a wide variety of means and combinations, all of which are anticipated by the present invention. In the embodiment illustrated in FIG. 6, the wheel assembly 54 vertical support rods 56 are each raised or lowered relative to the platform 11 until the appropriate and desired platform 11 height is achieved. As depicted in FIG. 9A, the platform 11 may be adjusted to a substantially level position relative to the floor 75 and elevated above the height of the cabinet floor 72 to negotiate over the toe kickboard 71. Alternatively, the technician may prefer to raise the head end 14 of the device platform 11 to a slightly higher elevation than the foot end 13 of the device platform 11 in order to provide a desirable inclined working position within the core of the cabinet 74 as depicted in FIG. 9B.

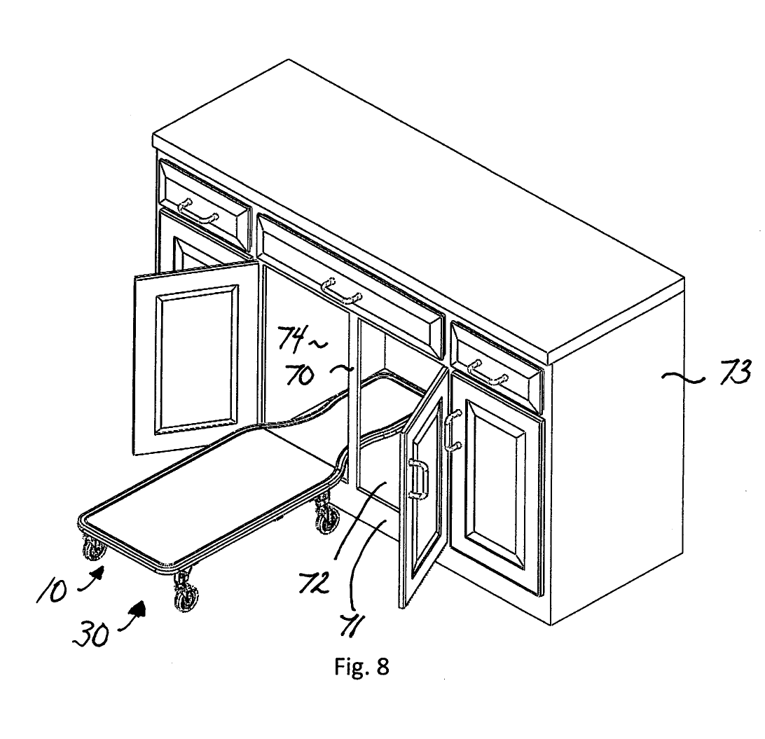

The body-carrying platform 11 further comprises two substantially semi-circle cutouts 15 provided within the cantilevered portion of the platform 11 at the head end 14 positioned along the longitudinal sides at substantially the same position along the longitudinal axis of the platform head end 14. The size and geometry of the two opposing semi-circle cutouts 15 is optional and are anticipated by the present invention, such that the one piece unibody creeper 10 embodiment and the folding two piece unibody creeper 30 embodiment can each be moved or placed into cabinets openings 74 exhibiting a smaller entry port 70 than the full width of the device as depicted FIG. 8. These semi-circle cutouts 15 also facilitate improved range of motion of the person's arms and shoulders while the head and upper torso remain supported by the head end 14.

The creeper device preferred embodiments 10 and 30 may further comprise one or more drawers 18 provided underneath the body of the device such that a technician may conveniently carry tools into the cabinet, locate such tools in the dark, return the tools to their proper place within the drawer, and avoid placing the tools in any dirt or grime that may be present on the cabinet floor. The preferred embodiments may further comprise a lighting lamp 19 on the head end 14. The lamps 19 is mounted on a flexible positional neck which attaches to the platform 11 or frame 12 so that the lamp 19 may also be stored out of the way or directed as desired. The preferred embodiments may further comprise a handle 17 attached to one or more of the longitudinal side edges of the platform 11 or frame 12 at a longitudinal position along the side of the device approximating the center of gravity so as to provide a balanced load distribution when the device is carried with the platform 11 surface in a plane substantially perpendicular to the ground when the longitudinal axis is parallel to the ground. The handle 17 may also comprise a strap, knobs, or similar carrying means including being integrally formed via a cutout, aperture or passage through the platform 11.

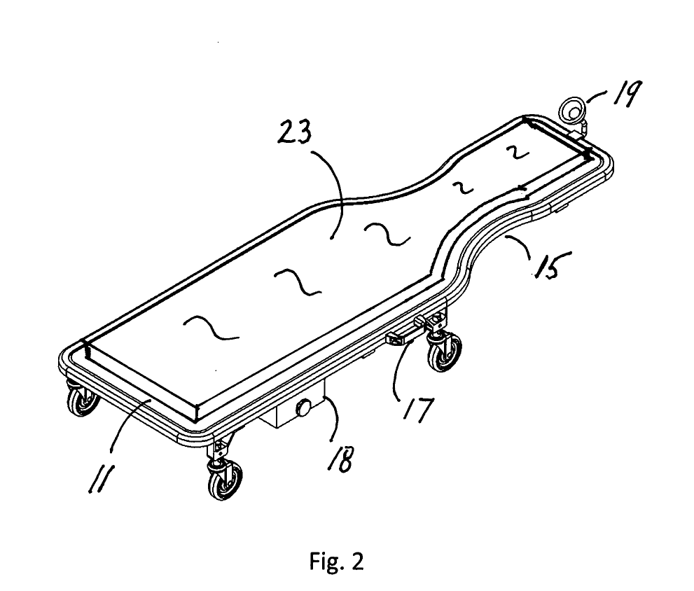

As depicted in FIG. 2, a cushion 23 or combination of cushions may be placed, mechanically attached or removeably attached to the platform 11 surface to provide a comfortable working surface and eliminate pressure points applied to the body. It is foreseen that those skilled in the art will recognize that the cushion 23 materials, coverings and attaching means may be accomplished in a wide variety of means and combinations, all of which are anticipated by the present invention.

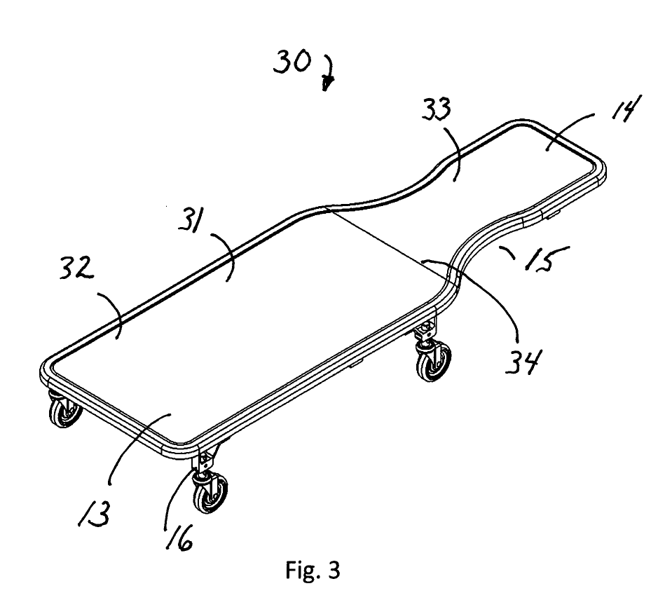

The folding two piece unibody creeper 30 embodiment is shown in FIGS. 3, 4 and 5. It comprises all of the advantages, features and elements disclosed for the one piece unibody creeper 10 embodiment while also facilitating the ability to collapse or fold the device substantially in half for convenient storage and transport. The device platform 31 still has a head end 14 and foot end 13 however, the platform is divided into two discrete sections via a sectional break 34 located immediately adjacent to the front edge of the forward pair of roller and height adjustment assemblies 16 and oriented substantially perpendicular to the longitudinal axis of the platform 31. The head end 14 platform section 33 and the foot end 13 platform section 32 are positioned together in juxtaposed substantially coplanar fashion along the sectional break 34 to form a single body support surface.

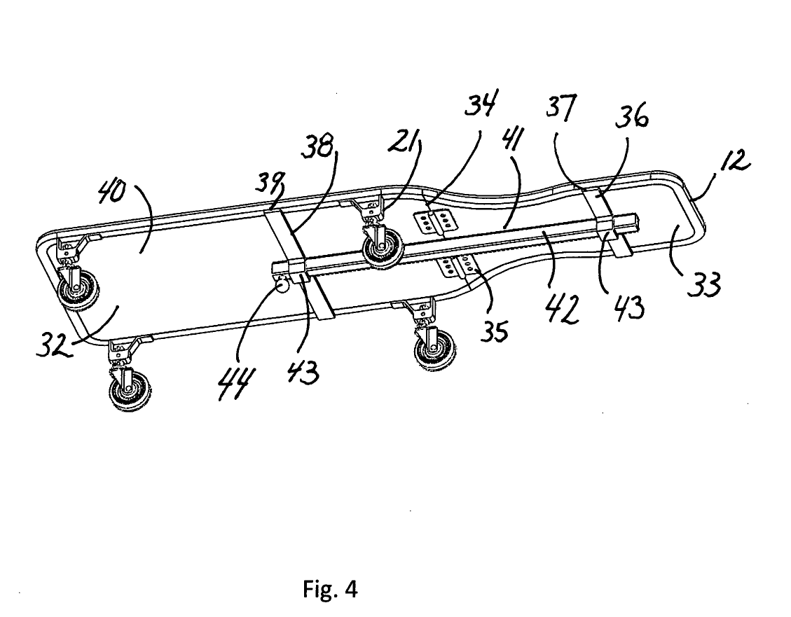

A bottom view of the folding two piece unibody creeper 30 embodiment is shown in FIG. 4. The two platform sections or segments are mechanically attached to one another with one or more hinges 35 spanning the sectional break 34. The preferred embodiment comprises two pinned hinges however those skilled in the art will recognize that a multitude of other hinge-type fasteners may be utilized such as piano hinges, strap hinges, off-set hinges, etc. all of which are anticipated in the present invention. The hinges 35 may be mechanically attached to two platform sections via conventional fastener techniques such as but not limited to screws, bolts, welding, adhesive and rivets. While the preferred embodiment has the hinges 35 located and affixed to the bottom surface of the platform segments 32 and 33, the hinges 35 may alternatively be positioned and mechanically affixed to vertical edges of each of the opposing platform segments within the sectional break 34 area. Still further, the hinges 35 may be affixed to the top surfaces of the two platform segments 32 and 33 to facilitate folding the two top surfaces together. Likewise, the hinge 35 means may be integrally formed or comprised within a fabricated or molded platform segment half and then pinned or otherwise interlocked together. The dual function hinge 35 means serves to structurally bridge and align the two platform segments together when in use, and then allow the two platform segments to collapse or fold onto each other when so desired.

FIG. 4 also depicts a slide bolt mechanism 41 which is utilized to lock and support the extended head end 14 platform segment 33 substantially co-planer with the foot end 13 platform 32 when in use. The foot end 13 platform segment 32 comprises at least one support bracket 38 which is mechanically attached to either the underside of the foot end 13 platform segment 32 or the frame 12 at location 39. Correspondingly, the head end 14 platform segment 33 comprises at least one receptacle bracket 36 which is mechanically attached to either the underside of the head end 14 platform segment 33 or the frame 12 at location 37. Each the support bracket 38 and the receptacle bracket 36 comprise a receptacle device 43 through which a slide bolt 42 is engaged. The preferred embodiment utilizes a slide bolt 42 with a square tubular cross-section made of light weight aluminum or steel and having the structural integrity and strength to support approximately a 300 pound body weight applied across the platform break 34. It is foreseen that those skilled in the art will recognize that a broad variety of slide bolt 42 and corresponding receptacle device 43 configurations and quantities may be utilized to lock and support the extended head end 14 platform segment 33 substantially co-planer with the foot end 13 platform 32 when in use, all of which are anticipated by the present invention. The slide bolt 42 further comprises a knob 44, loop, post, tab or similar convention to enable the technician to safely and firmly grasp the slide bolt 42 to apply the longitudinal force required to either extend or retract the slide bolt 42.

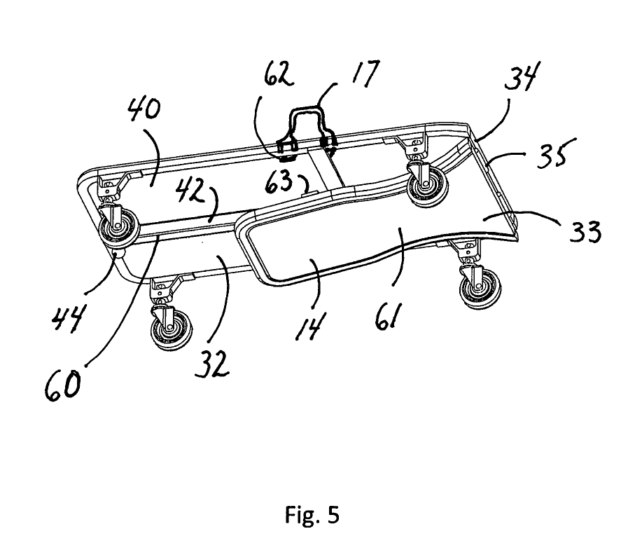

FIG. 5 depicts a bottom view of the folding two piece unibody creeper 30 embodiment with the locking bolt 42 disengaged from the receptacle 43 of the head end 14 platform segment 33 receptacle bracket 36 and with the slide bolt 42 retracted and positioned back toward the rear edge 60 of the foot end 13 platform segment 32. FIG. 5 also depicts the head end 14 platform segment 33 rotated about the hinges 35 and folded down and backwards to position 61 in which the forward roller and height adjustment assemblies 16 pass through the two substantially semi-circle cutouts 15 in the head end 14 platform segment 33, enabling the two platform segments to achieve a substantially parallel position. For the purposes of clarity, in FIG. 5 the orientation of the head end 14 platform segment 33 is shown during rotation and in an intermediate position 61 short of a complete 180 degree rotation for storage.

One or more conventional latch mechanisms 62 are mechanically affixed to or otherwise integrated with the bottom side of the frame 12 or foot end 13 platform segment 32 to receive and retain a corresponding latch keeper 63 mechanically affixed to or otherwise integrated with the bottom side of the head end 14 platform segment 33 to lock the two respective platform segments together for convenient transport and storage. The latch mechanism 62 and latch keeper 63 respective positions can be reversed in alternative embodiments. The latch mechanism is released when it is desired to unfold the two platform segments for use. When the head end 14 platform segment 33 has been rotated approximately 180 degrees to the substantially a co-planer position with the foot end 13 platform segment 32, the slide bar 42 can be pushed forward to engage the receptacle 43 of the head end 14 platform segment 33 receptacle bracket 36 to support and lock the head end 14 into the horizontal position. As with the one piece unibody creeper 10 embodiment, a handle 17 can be affixed to or otherwise integrated with the longitudinal side of the foot end 13 platform segment 32. The handle 17 is positioned in a location approximating the center of gravity so as to provide a balanced load distribution when the device is carried with the two latched platform segment surfaces in a plane substantially perpendicular to the ground when the longitudinal axis is parallel to the ground. The folding two piece unibody creeper 30 embodiment can likewise be equipped with platform cushions 23, drawers 18 and lighting lamps 19.

Although the device according to the present invention has been described in some detail, it is capable of numerous modifications by substituting now known or after-developed items that perform the same function as the parts described herein or depicted in FIGS. 1-9 without departing from the invention as defined in the appended claims.

What is claimed is:

1. A creeper to provide a substantially flat, rollable working surface capable of supporting a person in a supine position comprising:
a) a rigid planar platform having a top surface, a bottom surface, perimeter edge surfaces, a first end and a second end;
b) a plurality of wheels mounted proximate to said bottom surface for rollably engaging a floor or ground surface; and
c) said plurality of wheels being attached to said rigid planar platform in a spatial relationship relative to the first end of the platform so as to support the person's upper torso weight applied to the second end of the platform and entry into a confined workspace wherein the second end of the platform extends in an elevated cantilever fashion into the confined workspace and is not supported by any wheels.

2. The creeper of claim 1 further comprising a plurality of height adjustment mechanisms to change the distance of the wheels from the bottom surface of the platform in order to change the height of the platform relative to the floor or ground surface on which the wheels will be placed.

3. The creeper of claim 1 wherein the cantilevered platform extension comprises a narrower lateral width than the portion of the platform supported by the wheels to enable the creeper cantilevered extension to enter door openings of lesser width than that of the portion of the platform supported by the wheels.

4. The creeper of claim 1 wherein the cantilevered platform extension comprises a lateral narrowing geometric shape localized to the area of the platform extension immediately adjacent to the wheel(s) closest to the point of the cantilever fulcrum to enable the creeper cantilevered extension to negotiate door openings of lesser width than that of the portion of the platform supported by the wheels while providing a laterally wider work surface beyond the localized narrowing region.

5. The creeper of claim 4 wherein the cantilevered platform extension lateral narrowing geometric shapes are substantially in the form of two semi-circle cutouts with the corresponding radii facing each other.

6. The creeper of claim 1 further comprising any combination or plurality of carrying handles, storage drawers, platform cushions, wheel support bumpers or lighting lamps.

7. A foldable creeper to provide a substantially flat, rollable working surface capable of supporting a person in a supine position comprising:
a) a rigid planar platform further comprised of two movable platform segments hingeably attached to one another, each having a top surface, a bottom surface and perimeter edge surfaces;
b) a plurality of wheels mounted proximate to said bottom surface of one of the platform segments for rollably engaging a floor or ground surface;
c) said plurality of wheels being attached to said rigid planar platform segment in a spatial relationship substantially about the perimeter of the platform segment so as to support weight applied to the top surface of both or either platform segments;
d) said second platform segment being capable of being locked and supported in a position adjacent, juxtaposed to and co-planer with the platform segment comprising the wheels to form a cantilevered platform;
e) said cantilevered platform segment being supported and locked into the co-planer position by at least one moveable structural support member mechanism; and
f) said moveable structural support member mechanism being substantially perpendicular to the axis of the hinge system and bridging the platform comprising the wheels with the second platform segment to form an elevated cantilevered platform segment which is not supported by any wheels.

8. The creeper of claim 6 further comprising a plurality of height adjustment mechanisms to change the distance of the wheels from the bottom surface of the platform in order to change the height of the platform relative to the floor or ground surface on which the wheels will be placed.

9. The creeper of claim 6 wherein the cantilevered platform segment comprises a narrower width than the platform segment supported by the wheels to enable the creeper cantilevered extension to enter door openings of lesser width than that of the portion of the platform supported by the wheels.

10. The creeper of claim 6 wherein the cantilevered platform segment comprises a lateral narrowing cross section generally localized to the area of the platform extension starting immediately adjacent to the hinge system and the point of the cantilever fulcrum to enable the creeper cantilevered extension to negotiate door openings of lesser width than that of the platform segment supported by the wheels while providing a laterally wider work surface beyond the localized narrowing region.

11. The creeper of claim 10 wherein the cantilevered platform segment lateral narrowing geometric shapes are substantially in the form of two semi-circle cutouts with the corresponding radii facing each other.

12. The creeper of claim 6 wherein said moveable structural support member mechanism further comprises at least one moveable slide bolt and at least one slide bolt receiving receptacle mechanism affixed to each platform segment.

13. The structural support member mechanism of claim 12 further comprising the means to independently support and retain the moveable disengaged slide bolt to one of the platform segments in the fully retracted and disengaged position such that the moveable slide bolt lineal length does not cross the plane of the hinge system.

14. The creeper of claim 6 further comprising the ability to fold the cantileverable platform segment approximately 180 degrees about the hinge system axis until the bottom surface of the cantilevered platform is substantially in contact with the bottom surface of the wheeled platform segment.

15. The creeper of claim 14 further comprising at least one latch mechanism to secure the two platform segments together for ease of transport and storage.

16. The creeper of claim 10 wherein the forward wheel assemblies located immediately adjacent to the hinge system pass through the two opposing passages caused by the lateral narrowing cross section of the cantilevered segment during the folding operation to enable a substantially complete 180 degree rotation of the wheeless platform segment.

17. The creeper of claim 6 further comprising any combination or plurality of carrying handles, storage drawers, platform cushions, wheel support bumpers or lighting lamps.
